(19) United States
(12) Patent Application Publication
(10) Pub. No.: US 2021/0012447 A1
(43) Pub. Date: Jan. 14, 2021

(54) Method and System for Processing Firearm-Related Data

(71) Applicant: Veritransfer Inc., Henderson, CA (US)

(72) Inventors: Mathieu Glaude, Toronto (CA); Mark Lawson, Toronto (CA)

(21) Appl. No.: 16/510,530

(22) Filed: Jul. 12, 2019

(51) Int. Cl. G06Q 50/26; H04L 9/06; G06F 16/182

(52) U.S. Cl. CPC G06Q 50/265; G06F 16/1834; H04L 9/0643; H04L 9/0637

(57) ABSTRACT

Methods, systems, and techniques for processing firearm-related data. Stored on a blockchain are a hash of a firearm license and personal data identifying the licensee, which can be used to retrieve the hash from the blockchain. When the licensee wishes to acquire a firearm, the licensee produces a copy of the license that, to the vendor, is unverified. The vendor retrieves the hash from the blockchain and independently determines a hash of the unverified license. When the two hashes match, the vendor trusts that the previously unverified license is authentic. A non-blockchain database is also used to store a copy of the license, providing redundancy and data integrity/security.

### TECHNICAL FIELD

The present disclosure is directed at methods, systems, and techniques for processing firearm-related data.

### BACKGROUND

Firearm-related data may comprise data such as personal information identifying persons who own firearms (e.g., name and address) and a list of firearms owned by those persons. This data is highly sensitive. At the same time, it may be necessary to provide controlled access to this data in order to implement appropriate and reasonable safety checks when transferring firearms.

### SUMMARY

According to a first aspect, there is provided a method comprising: obtaining unverified hashed firearm license data representing a license purportedly licensing a licensee; retrieving, from a blockchain, trusted hashed firearm license data representing a license confirmed to license the licensee; comparing the unverified hashed firearm license data to the trusted hashed firearm license data; and when the unverified hashed firearm license data and the trusted hashed firearm license data match, determining that the unverified hashed firearm license data represents an authentic license of the licensee.

The unverified hashed firearm license data may be obtained together with a license identifier, and retrieving the trusted hashed firearm license data from the blockchain may be performed using the license identifier.

The unverified hashed firearm license data and the license identifier may be concurrently obtained from the licensee.

A non-fungible token stored on the blockchain may represent a firearm, and the method may further comprise, after the unverified hashed license data is determined to represent an authentic license of the licensee, storing on the blockchain a transaction evidencing transfer of the token to the licensee.

A validity state of the license may be stored on the blockchain, and the method may further comprise retrieving the validity state from the blockchain, and the transaction evidencing transfer of the token may be stored on the blockchain only if the validity state shows the license is valid.

The method may further comprise determining by accessing a data source storing a list persons disqualified from acquiring a firearm, and the transaction evidencing transfer of the token may be stored on the blockchain only if the licensee is absent from the list.

The license that the trusted hashed firearm license data represents may be stored on a non-blockchain database communicatively connected to the blockchain.

The database may be a distributed database.

The method may further comprise: receiving a request to access at least one of the trusted hashed firearm license data on the blockchain and the copy of the license stored on the database; determining whether the request is made by an authorized requester; and only responding to the request by sending the at least one of the trusted hashed firearm license data and the copy of the license when the request is made by the authorized requester.

Determining whether the request is made by the authorized requester may be performed using computer program code stored on the blockchain.

Determining whether the request is made by an authorized requester may comprise: comparing a blockchain address of a source of the request against a whitelist of allowed addresses; and determining that the request is made by the authorized requester when the blockchain address is on the whitelist.

According to another aspect, there is provided a method comprising: obtaining trusted hashed firearm license data representing a license confirmed to license a licensee; storing, on a blockchain, the trusted hashed firearm license and personal data identifying the licensee.

The personal data may comprise a blockchain address of the licensee.

The method may further comprise storing a validity state of the license on the blockchain.

The validity state may be initialized as invalid, and the method may further comprise: receiving a copy of the license; and storing on the blockchain a transaction evidencing setting of the validity state to valid.

The method may further comprise: receiving a copy of the license; and storing the copy of the license on a non-blockchain database communicatively connected to the blockchain.

The database may be a distributed database.

According to another aspect, there is provided a non-transitory computer readable medium having stored thereon computer program code that is executable by a processor and that, when executed by the processor, causes the processor to perform any of the foregoing aspects of the method or suitable combinations thereof.

According to another aspect, there is provided a system comprising: a processor; a network controller communicatively connected to the processor, the network controller for communicating with a blockchain; a non-transitory computer readable medium having stored thereon computer program code that is executable by the processor and that, when executed by the processor, causes the processor to perform a method comprising: obtaining unverified hashed firearm license data representing a license purportedly licensing a licensee; retrieving, from the blockchain, trusted hashed firearm license data representing a license confirmed to license the licensee; comparing the unverified hashed firearm license data to the trusted hashed firearm license data; and when the unverified hashed firearm license data and the trusted hashed firearm license data match, determining that the unverified hashed firearm license data represents an authentic license of the licensee.

The unverified hashed firearm license data may be obtained together with a license identifier, and retrieving the trusted hashed firearm license data from the blockchain may be performed using the license identifier.

The unverified hashed firearm license data and the license identifier may be concurrently obtained from the licensee.

A non-fungible token stored on the blockchain may represent a firearm, and the method may further comprise, after the unverified hashed license data is determined to represent an authentic license of the licensee, storing on the blockchain a transaction evidencing transfer of the token to the licensee.

A validity state of the license may be stored on the blockchain, and the method may further comprise retrieving the validity state from the blockchain. The transaction evidencing transfer of the token may be stored on the blockchain only if the validity state shows the license is valid.

The method may further comprise determining by accessing a data source storing a list persons disqualified from acquiring a firearm, and the transaction evidencing transfer of the token may be stored on the blockchain only if the licensee is absent from the list.

The license that the trusted hashed firearm license data represents may be stored on a non-blockchain database communicatively connected to the blockchain.

The database may be a distributed database.

The method may further comprise: receiving a request to access at least one of the trusted hashed firearm license data on the blockchain and the copy of the license stored on the database; determining whether the request is made by an authorized requester; and only responding to the request by sending the at least one of the trusted hashed firearm license data and the copy of the license when the request is made by the authorized requester.

Determining whether the request is made by the authorized requester may be performed using computer program code stored on the blockchain.

Determining whether the request is made by an authorized requester may comprise: comparing a blockchain address of a source of the request against a whitelist of allowed addresses; and determining that the request is made by the authorized requester when the blockchain address is on the whitelist.

According to another aspect, there is provided a system comprising: a processor; a network controller communicatively connected to the processor, the network controller for communicating with a blockchain; a non-transitory computer readable medium having stored thereon computer program code that is executable by the processor and that, when executed by the processor, causes the processor to perform a method comprising: obtaining trusted hashed firearm license data representing a license confirmed to license a licensee; storing, on the blockchain, the trusted hashed firearm license and personal data identifying the licensee.

The personal data may comprise a blockchain address of the licensee.

The method may further comprise storing a validity state of the license on the blockchain.

The validity state may be initialized as invalid, and the method may further comprise: receiving a copy of the license; and storing on the blockchain a transaction evidencing setting of the validity state to valid.

The method may further comprise: receiving a copy of the license; and storing the copy of the license on a non-blockchain database communicatively connected to the blockchain.

The database may be a distributed database.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a system for managing firearm-related data, according to an example embodiment.

FIG. 2 depicts a data exchange between certain components of the system of FIG. 1 when a user registers a firearm license using that system.

FIG. 3 depicts a data exchange between certain components of the system of FIG. 1 when a firearm vendor confirms the validity of a license of a firearm licensee wishing to purchase a firearm.

FIG. 4 depicts a flow diagram of a firearm licensee and a vendor engaging in a firearm transfer using the system of FIG. 1.

FIG. 5 depicts a system for managing firearm-related data, according to another example embodiment.

FIG. 6 depicts a software framework used for the software comprising part of the system of FIG. 1.

FIG. 7A, FIG. 7B, FIG. 7C and FIG. 7D depict example screenshots of a user interface representing different operational states of the systems of FIGS. 1 and 5.

### DETAILED DESCRIPTION

Firearm-related data is highly sensitive information. For example, firearm-related data may comprise information that personally identifies firearm owners (e.g., those owners' names, addresses, phone numbers, and e-mail addresses), the various firearms owned by those owners, whether those owners have a criminal record, and/or the mental health history of those owners. While there may be public benefit in recording this data such that authorized persons can have controlled access to it, such as during security checks when a firearm is sold or to modify it when a firearm owner is convicted of a crime, doing so raises data security and privacy concerns. Given the sensitive nature of firearm-related data, data integrity and security are paramount; at odds with this is the practical requirement that the data be readily accessible in a practical and user friendly manner when needed.

At least some of the embodiments described herein address these competing concerns using a blockchain-based system for processing firearm-related data. The system uses a hybrid storage system comprising a blockchain and a non-blockchain database, which store complementary information. For example, the non-blockchain database may store digital copies of firearm licenses and/or identification cards, and the blockchain may store hashes of those copies. By virtue of being stored on a blockchain, the hashes can practically be treated as immutable. Having complementary data stored in different forms on different media provides redundancy to the system, which makes it more difficult for malicious actors to corrupt the data. Additionally, storing the hashes on the blockchain and not the licenses and/or cards themselves reduces the amount of data stored on the blockchain, thereby also reducing network and storage requirements of the nodes hosting the blockchain. Using a blockchain also facilitates distributed ownership as opposed to centralized (e.g., government) ownership of the data, which may be desirable to certain users of the system.

As used herein, a “firearm license” and related license data includes but is not limited to a license specifically issued to authorize the purchase of firearms. An example of a firearms license specifically issued to permit the purchase of firearms is a

Possession and Acquisition License (“PAL”) in Canada or a concealed carry license in certain U.S. states. However, in some other jurisdictions such as in at least some places in the United States no license specific to firearms may be required. Instead, some other license associated with a firearm purchase, such as a driver's license or other identification card to confirm licensee age, is included in the definition of “firearm license” herein.

A blockchain comprises computer nodes on which a distributed database is collectively stored. The database is stored as a chain of “blocks”. The first block in the blockchain is known as a “genesis block”, and every other block in the blockchain is directly linked in a cryptographically secure manner to an immediately preceding block in the chain. This is one way in which any one of the nodes can check the validity of the blockchain.

New blocks added to the blockchain are referred to as being “higher” in the blockchain than the blocks added to the blockchain prior to it; the genesis block is accordingly the “lowest” block in the blockchain. Because each block in the blockchain is directly linked to its immediately preceding block, any block in the blockchain can, directly or indirectly, be traced back to the genesis block.

Different blockchains may be implemented in different ways. In one example blockchain, the bitcoin blockchain, each block of the blockchain comprises that block's size, in bytes; a block header; a transaction counter, representing the number of different bitcoin transactions stored in that block; and transaction data, which are the stored transactions. The block header for each block comprises version information; a previous block hash, which is a reference to the hash of the block immediately preceding that block; a Merkle root, which is a hash of the Merkle tree root of the transactions stored in that block; a timestamp, which is when the block was created; a difficulty target, which is the minimum difficulty that had to be satisfied when performing a proof-of-work operation during block creation; and a nonce, resulting from the proof-of-work.

Using the bitcoin blockchain as an example, different nodes forming the blockchain compete to generate new blocks by performing a proof-of-work operation that satisfies the difficulty target specified in each of the new blocks' headers. Once generated, a new block is disseminated to, and its authenticity is independently verified by, other nodes in the blockchain by using the previous block hash (to confirm that new block's lineage) and Merkle root (to confirm the validity of the transactions stored in that new block). Following verification, the new block is added to the top of the blockchain. The bitcoin blockchain at any given time is typically the chain having blocks resulting from the highest possible cumulative proof-of-work. The nodes are said to have arrived at “consensus” when they agree as to which block is to be added to the top of the blockchain. Each block is cryptographically linked to its immediately preceding block; consequently, blocks far from the top of the blockchain are, for practical purposes, immutable.

Cryptographic tokens permit users to exchange resources or assets with each other in a cryptographically secure manner. Each type of cryptographic token may be associated with a particular blockchain on which transactions involving that token are recorded. For example, one example type of cryptographic token is the Ether™ token, for which transactions are recorded on the Ethereum™ blockchain. Another example type of cryptographic token is bitcoin, for which transactions are recorded using the bitcoin blockchain.

In at least some example embodiments herein, non-fungible cryptographic tokens such as the ERC-721 token standard developed for the Ethereum™ blockchain are used to represent firearms. One of these tokens can be transferred from one user of the system to another to represent a transfer in ownership of a firearm.

Each user who wishes to be able to send and receive cryptographic tokens such as the non-fungible token described above has a digital wallet that stores one or more public/private key pairs. For each pair, the private key is kept secret by that user and the public key is made publicly available. One or more tokens are transferred from a first user to a second user in a transaction. For example, a transaction may record that a number of tokens are being transferred from the first user to a public address (hereinafter interchangeably referred to as a “blockchain address”) of a second user, with that address being based on the second user's public key. The first user digitally signs the transaction using the first user's private key for authentication purposes. The transaction is then recorded on the blockchain with which the cryptographic token is associated, which requires another block to be added to that blockchain. A reference to a first user “transferring” a cryptographic token to a second user refers to the blockchain being used to record a transaction in which the token is sent to the second user's public address in this or an analogous manner. A reference to a cryptographic token being “stored” in a digital wallet refers to that token having been sent to a public address generated from a public key associated with that wallet.

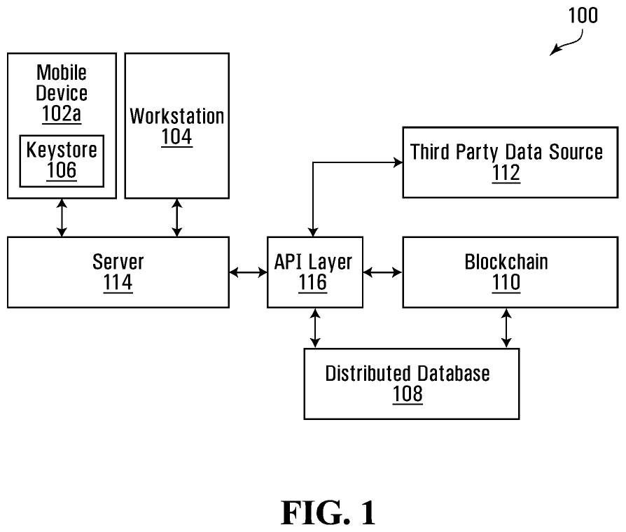

Referring now to FIG. 1, there is shown an example embodiment of a system 100 for processing firearm-related data, according to an example embodiment. The system 100 comprises a server 114 that comprises part of a back-end infrastructure, which may be implemented as a scalable microservice. While in FIG. 1 a single server is depicted, in at least some different example embodiments a network of servers and/or other computing devices may be used as part of the back-end infrastructure. The server 114 is communicatively connected to a mobile device 102a of a firearm licensee storing a keystore 106, a workstation 104 that may be used to host an administrative dashboard for configuring and administering the system 100, and an application programming interface (“API”) layer 116 that permits that back-end infrastructure 114 to interface with a third party data source 112, a blockchain 110, and a non-blockchain distributed database 108. Each of the server 114, the mobile device 102, and the workstation 104 may comprise a processor, a non-transitory computer readable medium, and a network interface controller that are communicatively connected to each other. For each of the server 114, the mobile device 102a, and the workstation 104, the non-transitory computer readable medium may store computer program code that is executable by each device's processor and that, when executed by that processor, causes each of the server 114, the mobile device 102a, and the workstation 104 to perform the functionality attributed to them herein.

The mobile device 102a runs a mobile application that comprises a mobile wallet that has access to the keystore 106. The mobile application allows a firearm licensee using the device 102a to manage the licensee's firearms inventory and to transact with other users of the system 100 and the firearms marketplace more generally, as discussed further below. The keystore 106 stores a licensee's private keys.

The workstation 104 provides, in at least some example embodiments, access to an administrative interface that may be a web-based application used by users such as governments and federal firearm license sellers for analytics, attestations, and permissions management.

The API layer 116 may be implemented as computer program code stored on the server's 114 computer readable medium, and permit the server 114 to communicate with the third party data source 112, the blockchain 110, and the distributed database 108.

The third party data source 112 may be, for example, a third party data oracle from which trusted information is obtained (e.g., a government database). Examples of information retrieved from the source 112 comprise information related to jurisdictional compliance, firearm serial number registries, criminal record files, medical records (e.g., mental health history), and background checks or other lists of persons disqualified from or whose rights in respect of acquiring firearms are otherwise limited (e.g., using the U.S. National Instant Criminal Background Check System).

The blockchain 110 may be based on the Hyperledger Fabric™ blockchain framework. The blockchain 110 is a permissioned (i.e., private) blockchain 110 in FIG. 1, although in at least some other example embodiments may be public. While the Hyperledger Fabric™ blockchain framework is used in FIG. 1, in at least some different example embodiments a different blockchain implementation, such as the Ethereum™ blockchain or the Aion™ blockchain, may be used.

The distributed database 108 is used to store information that isn't stored on the blockchain 110. An example of a distributed database 108 that may be used is one based on the InterPlanetary File System (“IPFS”).

### Smart Contracts for Licensing and Firearm Transfer

The blockchain 110 is used to track firearm provenance and ownership. Each user of the system 100 is represented on the blockchain 110 with an anonymous account; an identity layer is added over the anonymous accounts that associates the accounts with respective identities that can be used for proving ownership and tracking provenance. Smart contracts in the form of computer program code stored on the blockchain 110 act as functions or programs that are executable by the blockchain 110, such as to facilitate user licensing and firearm transfer.

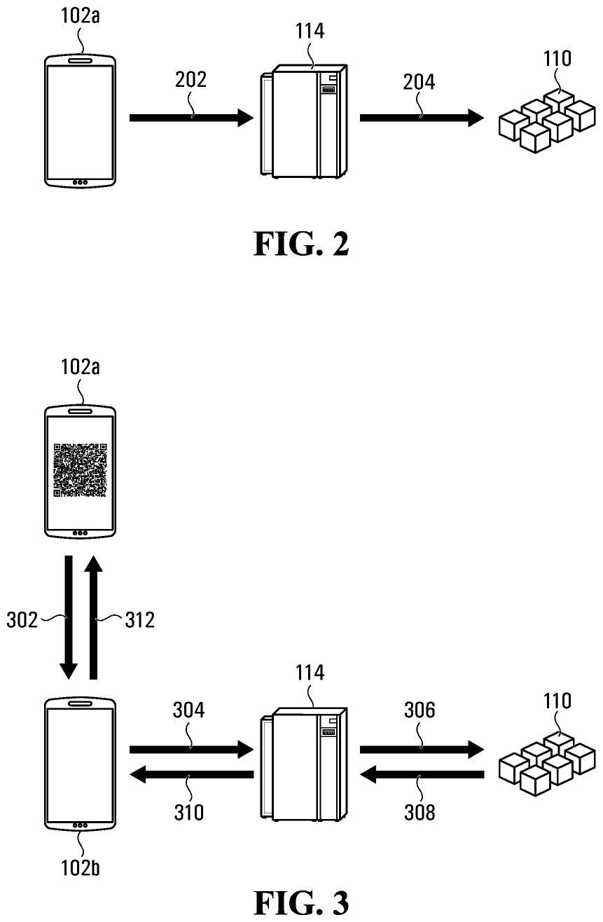

In order to register and onboard a new licensee to the system 100, the blockchain 110 executes computer program code hereinafter interchangeably referred to as the “licensing smart contract”. FIG. 2 depicts a data exchange between the mobile device 102a, server 114, and blockchain 110 when a licensee registers a firearm license using the system 100.

To begin, the licensee downloads the mobile application on to the mobile device 102a. The licensee creates login information, which creates a unique address on the blockchain 110. That is, in response to the licensee creating login information, the licensee also obtains a public/private key pair that permits the licensee to transfer tokens on the blockchain 110. The licensee inputs personal information (e.g., name, address, and social security number), and any relevant licensing documents (e.g., a firearm license such as a PAL in Canada or, in certain jurisdictions where no specific firearm license required, proof of age such as a driver's license). Inputting relevant documents may comprise, for example, inputting a scanned version of those documents. Alternatively or additionally, inputting relevant documents may comprise inputting certain data from those documents, such as a serial or registration number.

Once the licensee's personal information and licensing documents are entered, they are transferred to the server 114 (arrow 202). The transmitted data may be packaged into an appropriate data structure for transfer; for example, in at least some embodiments the licensee's personal information (“personal data”) and licensing documents (“license data”) are packaged into a Javascript Object Notation (“JSON”) file and transmitted. The server 114 receives the personal and license data and determines a hash of the license data. The server 114 may apply any suitable hashing method, such as the SHA-3 Keccak-256 cryptographic hash, which outputs a 64 character hash. The hash is one-way (i.e., the license data cannot be recreated from the hash of the license data) and uniquely represents the license data.

To add a license to the blockchain 110, a transaction containing the hash of the license data is sent from the licensee's blockchain account to an addlicense function on the licensing smart contract (arrow 204). The licensing smart contract records the license data hash and the licensee's blockchain address on the blockchain 110; the licensee's blockchain address acts as license identifier and allows the licensing smart contract to retrieve the license data hash from the blockchain 110. The licensing smart contract also initializes the license in an invalid state. The licensing smart contract also stores a copy of the license data, in its unhashed form, on the distributed database 108.

In addition to storing a copy of the license data in its unhashed form on the distributed database 108 and a hash of the license data on the blockchain 110, more generally the system 100 may store data on the distributed database 108 and a hash of that data on the blockchain 110. The data stored in this manner may comprise, for example, personal data of the licensee (e.g., date of birth, data describing physical characteristics, social security number) and a listing of firearms owned by the licensee. Similar to how license validity state may be stored on the blockchain 110, validity state information for other types of data may also be stored on the blockchain 110. For example, where information regarding what firearms a licensee owns is stored in the distributed database 108 and the hash of this information is stored on the blockchain 110, the blockchain 110 may also store information regarding whether each of those firearms has been stolen or not. If the firearm has been stolen, then the system 100 may not transfer that firearm; this is analogous to the system 100 not transferring a firearm for a license that the license validity data on the blockchain 110 indicates is invalid.

In order to transition the license from the invalid state to a valid state, the licensee proceeds to meet an attester (e.g., a federally licensed firearm vendor or a government representative). The method of attestation may be done differently in different example embodiments. In at least some example embodiments, the licensee provides the attester with the licensee's blockchain address and license data hash; this may be transmitted, for example, by means of a QR code on the licensee mobile device 102a. The attester confirms the validity of the data using, for example, the workstation 104 and related administrative dashboard to retrieve, review, and approve the copy of the licensee's license stored on the distributed database 108 using the blockchain address obtained from the licensee's QR code. The attester subsequently uses the licensing smart contract to set the license's state to valid. The server 114 may store in a whitelist a list of users, such as an employee at a federally licensed firearms dealer, who may validate or invalidate licenses. Attestation may be done differently in at least some other example embodiments. For example, the licensee may bring a physical copy of the license to the attester, which the attester may verify. The attester may then determine the hash of the physical copy of the license and retrieve and compare that hash against the corresponding hash stored on the blockchain 110, as described above. If the hashes match, the attester may subsequently use the licensing smart contract to set the license's state to valid.

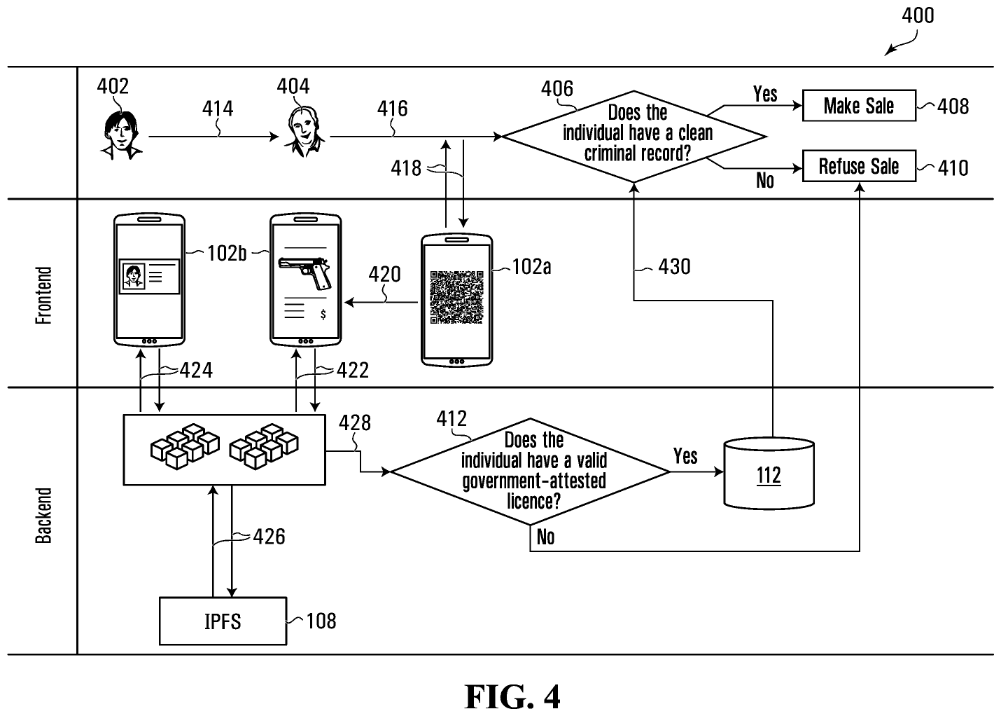

FIG. 3 depicts a data exchange between the licensee mobile device 102a, a vendor mobile device 102b, the server 114, and the blockchain 110 when a firearm vendor confirms the validity of a license of a licensee wishing to purchase or otherwise acquire ownership of a firearm. The data exchange shown in FIG. 3 is handled by computer program code stored on the blockchain 110 that is hereinafter interchangeably referred to as the “firearm smart contract”.

In FIG. 3, a user who is a licensee and who wishes to purchase a firearm presents the licensee mobile device 102a to the firearm vendor. The licensee mobile device 102a runs a mobile application that transfers, such as by using a QR code, the licensee's personal data, which comprises the licensee's blockchain address, and license data to the vendor mobile device 102b which the vendor uses (arrow 302). The licensee's blockchain address can be used to find the hash of the licensee's license data on the blockchain 110. After the vendor scans the licensee's QR code, the vendor mobile device 102b sends to the server 114 a copy of the licensee's personal data (arrow 304). The server 114, in turn, sends the blockchain address to the blockchain 110 and requests the firearm smart contract on the blockchain 110 to return the hash of the firearm license stored on the blockchain 110 (arrow 306). The firearm smart contract returns the hash to the server 114 (arrow 308), which relays it to the vendor mobile device 102b (arrow 310). The vendor mobile device 102b determines the hash of the license data received from the licensee mobile device 102a and compares it to the hash received from the server 114, which is what is stored on the blockchain 110. If the hashes match, the vendor mobile device 102b determines that the licensee's license is valid; if the hashes do not match, the vendor mobile device 102b determines that the licensee's license is invalid. The vendor mobile device 102b transmits the validity determination to the licensee mobile device 102a (arrow 312). While in this depicted example embodiment the vendor mobile device 102b performs the comparison and determines validity, in at least some different example embodiments another component of the system 100 such as the server 114 or licensee mobile device 102a may make this comparison. Additionally, in at least some other example embodiments the hash of the license data may additionally or alternatively be stored or determined on the licensee mobile device 102a itself and used for a comparison performed on the licensee mobile device 102a or transmitted to elsewhere in the system 100 (e.g., to the vendor mobile device 102b or server 114) for use in a comparison there.

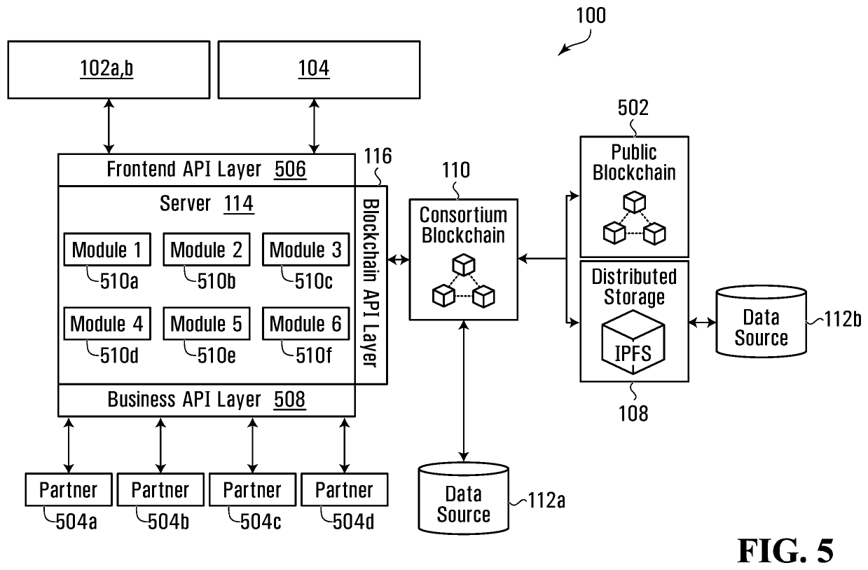

Determining license validity is one operation performed when using the system 100 to transfer firearm ownership, a method for which is depicted in the flow diagram 400 of FIG. 4. In FIG. 4, the licensee 402 asks to purchase a firearm from the vendor 404 (arrow 414). Prior to selling the firearm, the vendor 404 determines whether the licensee is eligible to purchase the firearm (arrow 416); in this example, this requires the licensee to have a valid license, and also to pass a background check comprising not having a criminal record. Determining license validity (arrows 418) is done in accordance with the description for FIG. 3 above. Namely, the vendor 404 scans the licensee's QR code and obtains the licensee's personal and license data (arrow 420). In the example embodiment of FIG. 4, the licensee's license data comprises the licensee's driver's license (depicted in the leftmost vendor mobile device 102b in FIG. 4). The vendor mobile device 102b sends the licensee's blockchain address to the server 114, which retrieves and relays the hash of the licensee's license data and the license's validity state to the vendor mobile device 102b (arrows 424). The vendor mobile device 102b is then able to re-determine the hash of the license data from the license data received from the licensee mobile device 102a and compare it to the trusted hash retrieved from the blockchain 110. This allows the vendor mobile device 102b to determine whether the license presented by the licensee 402 is authentic and valid (arrow 428 and block 412). If the license is invalid, the sale is refused (block 410).

In FIG. 4, the vendor mobile device 102b also obtains the licensee's firearm inventory (depicted in the rightmost vendor mobile device 102b in FIG. 4). The vendor mobile device 102b obtains this information from the firearm smart contract on the blockchain 110 (arrows 422), which in turn retrieves the information from the distributed database 108 (arrows 426).

If the vendor mobile device 102b determines that the licensee 402 has a valid license, then as part of the background check the system 100 queries a third party data source 112 (e.g., a government database) to determine whether the licensee 402 has a criminal record (block 406). If the licensee 402 does not have a clean criminal record, the firearm sale is again refused (block 410). If the licensee 402 does have a clean criminal record, the firearm sale is approved (block 408).

Firearms in the system 100 are represented using cryptographic tokens and, in at least some embodiments, non-fungible tokens. The tokens may be, for example, based on the ERC-721 standard. Each of the non-fungible tokens is uniquely paired with a particular firearm (e.g., using the firearm's serial no.). Functions in the ERC-721 standard such as ownerOf, takeOwnership, and transfer that identify the token by unique number and associate it with an owner, and the metadata function tokenMetadata that connects the unique token to additional data such as firearm serial no., may be used to facilitate firearm ownership transfers.

To transfer a firearm, the firearm smart contract transfers the token representing that firearm from the vendor's 404 blockchain address to the licensee's 402 blockchain address. The transfer is stored using the blockchain 110, thereby providing an immutable record of the transfer.

Each of the licensing and firearm smart contracts uses “modifiers” to enforce permissioned security for the system's 100 users. Using modifiers, the functions within the smart contracts may be programmed to only respond to specific users. For example, modifiers may be used to guarantee that firearm data can only be created and transferred by authorized requesters, such as certain vendors (e.g., a federally licensed firearms dealer [“FFL”]) or the licensees themselves. The immutable nature of the blockchain 110 combined with the use of modifiers mitigates the risk of tampering or manipulating of information stored on the blockchain 110. Each time a user of the system 100 makes a transaction on the blockchain 110, it is saved. The server 114 periodically checks for such transactions, updating regularly (e.g., every 5 or 10 seconds) to ensure that any new transactions are recorded on the blockchain 110.

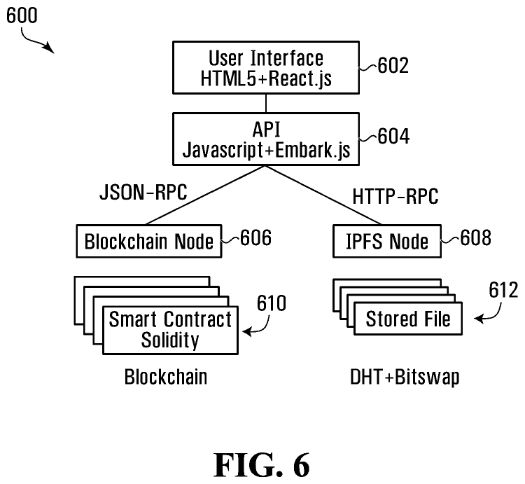

Referring now to FIG. 5, there is depicted a system 100 for managing firearm-related data, according to another example embodiment. The system 100 of FIG. 5 is similar to the system 100 of FIG. 1 in that both comprise a server 116 communicatively connected to mobile devices 102a,b, the workstation 104, the blockchain 110, the non-blockchain distributed storage 108, and third party data sources 112a,b. In contrast to the system 100 of FIG. 1, in FIG. 5 a first data source 112a is connected to the blockchain 110 and a second data source 112b is connected to the distributed database 108 as opposed to a single data source 112 being directly connected to the API layer 116. These data sources 112a,b may be treated as data oracles for data such as license compliance conditions. The system 100 of FIG. 5 also includes a public (as opposed to a permissioned) blockchain 502, that is communicatively connected to the permissioned blockchain 110. The public blockchain 502 serves as a publicly accessible backup for a subset of the information on the permissioned blockchain 110. A frontend API layer 506 is used to mediate communications between the server 114 and the mobile devices 102a,b and workstation 104. Additionally, a business API layer 508 is used to mediate communications between the server 114 and first through fourth partner workstations 504a-d, which may permit entities such as FFLs or government agencies to access the server 114. The server 114 in

FIG. 5 also additionally comprises computer program code in the form of first through sixth application modules 510a-f that implement in a modular fashion the server's 114 microservices. For example, the modules 510a-f may implement functionality such as account management and user identification/verification.

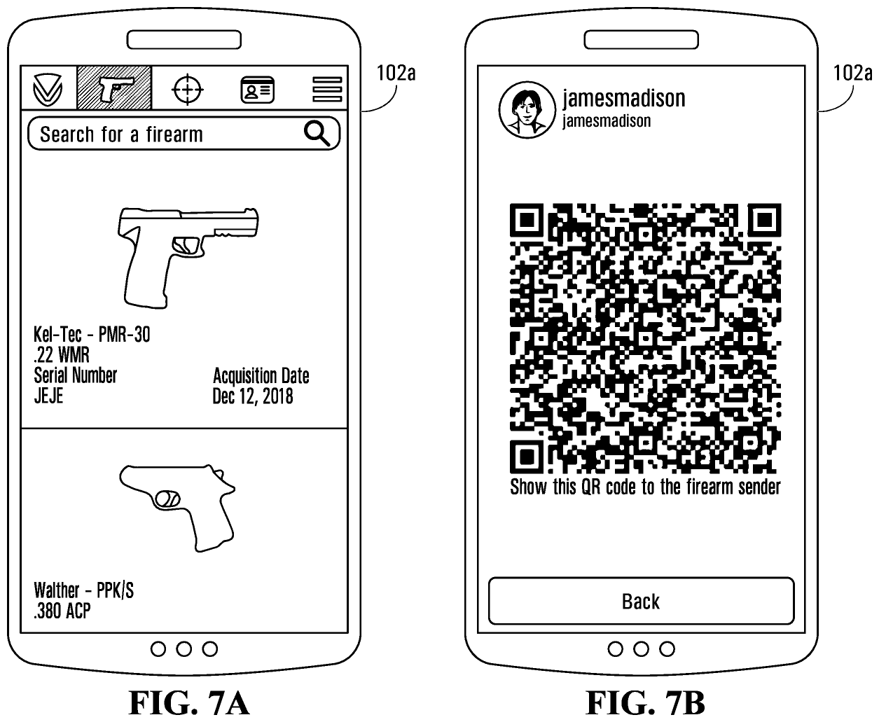

FIG. 6 depicts a software framework 600 used for the software comprising part of the system 100 of FIG. 1. The user interface displayed on the mobile devices 102a,b and on the workstation 104 is implemented using HTML5 and React.js (block 602). The API layer 116 is implemented using Javascript and Embarkjs (block 604). Communication between the API layer 116 and the nodes 606 comprising the blockchain 110 is performed using the JSON remote procedure call (“JSON-RPC”) protocol, and the smart contracts 610 on the blockchain 110 are implemented using the Solidity™ language. Communication between the API layer 116 and the IPFS nodes 608 that comprise the distributed database 108 is performed using the HTTP remote procedure call (“HTTP-RPC”) protocol, and various files 612 are stored on the distributed database 108. The distributed database 108 is also implemented using a distributed hash table (“DHT”) and uses Bitswap as a data trading module.

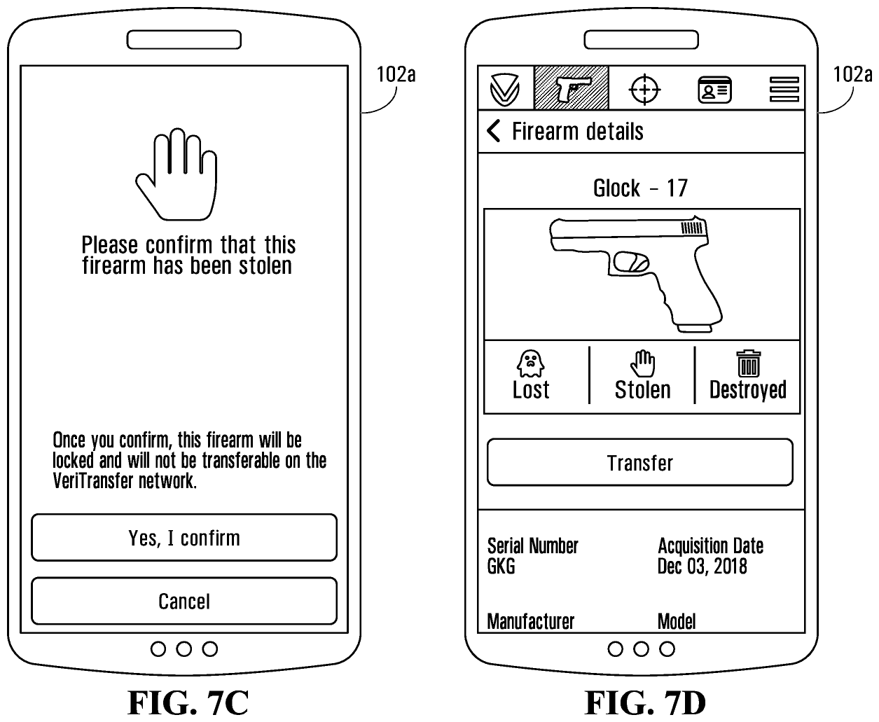

Referring now to FIGS. 7A-7D, there are depicted example screenshots of a user interface of the licensee mobile device 102a representing different operational states of the systems 100 of FIGS. 1 and 5. FIGS. 7A and 7D represent screenshots of a licensee perusing through the licensee's gun inventory, with FIG. 7A depicting a screenshot showing multiple guns in the inventor and FIG. 7D depicting a screenshot showing details associated with a single gun in the inventory. Gun inventory data is an example of data that may be stored in the distributed database 108 and whose hash may be stored on the blockchain 110 to facilitate retrieval and comparison by the vendor mobile device 102b, as desired. FIG. 7B depicts a screenshot showing the QR code that the licensee mobile device 102a displays to transmit personal and license data to the vendor mobile device 102b during a firearm transfer, as discussed above in respect of FIGS. 3 and 4. FIG. 7C depicts a screenshot allowing a licensee to mark a firearm in the licensee's firearm inventory as stolen. Once marked, the system 100 prevents any transfers of the stolen firearm from being performed using the system 100 and consequently from being recorded in the blockchain 110. For example, in another example embodiment in parallel with block 412, the flow diagram 400 may comprise querying the distributed database 108 to determine whether the firearm to be transferred has been stolen and proceed directly to block 410 where the sale is refused if so.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims. It is also to be understood that implementing a blockchain inherently requires computer equipment, such as a processor for creating and authenticating new blocks, storage for storing the blockchain, and a network interface for allowing communication between nodes, which is required for consensus.

One or more example embodiments have been described by way of illustration only. This description is been presented for purposes of illustration and description, but is not intended to be exhaustive or limited to the form disclosed. It will be apparent to persons skilled in the art that a number of variations and modifications can be made without departing from the scope of the claims.

1. A method comprising:
(a) obtaining unverified hashed firearm license data representing a license purportedly licensing a licensee;
(b) retrieving, from a blockchain, trusted hashed firearm license data representing a license confirmed to license the licensee;
(c) comparing the unverified hashed firearm license data to the trusted hashed firearm license data; and
(d) when the unverified hashed firearm license data and the trusted hashed firearm license data match, determining that the unverified hashed firearm license data represents an authentic license of the licensee.

2. The method of claim 1, wherein the unverified hashed firearm license data is obtained together with a license identifier, and wherein retrieving the trusted hashed firearm license data from the blockchain is performed using the license identifier.

3. The method of claim 2, wherein the unverified hashed firearm license data and the license identifier are concurrently obtained from the licensee.

4. The method of claim 1, wherein a non-fungible token stored on the blockchain represents a firearm, and further comprising, after the unverified hashed license data is determined to represent an authentic license of the licensee, storing on the blockchain a transaction evidencing transfer of the token to the licensee.

5. The method of claim 4, wherein a validity state of the license is stored on the blockchain, and further comprising retrieving the validity state from the blockchain, wherein the transaction evidencing transfer of the token is stored on the blockchain only if the validity state shows the license is valid.

6. The method of claim 4, further comprising determining by accessing a data source storing a list persons disqualified from acquiring a firearm, and wherein the transaction evidencing transfer of the token is stored on the blockchain only if the licensee is absent from the list.

7. The method of claim 1, wherein the license that the trusted hashed firearm license data represents is stored on a non-blockchain database communicatively connected to the blockchain.

8. The method of claim 7, wherein the database is a distributed database.

9. The method of claim 7, further comprising:
(a) receiving a request to access at least one of the trusted hashed firearm license data on the blockchain and the copy of the license stored on the database;
(b) determining whether the request is made by an authorized requester; and
(c) only responding to the request by sending the at least one of the trusted hashed firearm license data and the copy of the license when the request is made by the authorized requester.

10. The method of claim 9, wherein determining whether the request is made by the authorized requester is performed using computer program code stored on the blockchain.

11. The method of claim 9, wherein determining whether the request is made by an authorized requester comprises:
(a) comparing a blockchain address of a source of the request against a whitelist of allowed addresses; and
(b) determining that the request is made by the authorized requester when the blockchain address is on the whitelist.

12. A system comprising:
(a) a processor;
(b) a network controller communicatively connected to the processor, the network controller for communicating with a blockchain;
(c) a non-transitory computer readable medium having stored thereon computer program code that is executable by the processor and that, when executed by the processor, causes the processor to perform a method comprising:
(i) obtaining unverified hashed firearm license data representing a license purportedly licensing a licensee;
(ii) retrieving, from the blockchain, trusted hashed firearm license data representing a license confirmed to license the licensee;
(iii) comparing the unverified hashed firearm license data to the trusted hashed firearm license data; and
(iv) when the unverified hashed firearm license data and the trusted hashed firearm license data match, determining that the unverified hashed firearm license data represents an authentic license of the licensee.

13. The system of claim 12, wherein the unverified hashed firearm license data is obtained together with a license identifier, and wherein retrieving the trusted hashed firearm license data from the blockchain is performed using the license identifier.

14. The system of claim 13, wherein the unverified hashed firearm license data and the license identifier are concurrently obtained from the licensee.

15. The system of claim 12, wherein a non-fungible token stored on the blockchain represents a firearm, and wherein the method further comprises, after the unverified hashed license data is determined to represent an authentic license of the licensee, storing on the blockchain a transaction evidencing transfer of the token to the licensee.

16. The system of claim 15, wherein a validity state of the license is stored on the blockchain, and wherein the method further comprises retrieving the validity state from the blockchain, wherein the transaction evidencing transfer of the token is stored on the blockchain only if the validity state shows the license is valid.

17. The system of claim 15, wherein the method further comprises determining by accessing a data source storing a list persons disqualified from acquiring a firearm, and wherein the transaction evidencing transfer of the token is stored on the blockchain only if the licensee is absent from the list.

18. The system of claim 12, wherein the license that the trusted hashed firearm license data represents is stored on a non-blockchain database communicatively connected to the blockchain.

19. The system of claim 18, wherein the database is a distributed database.

20. The system of claim 18, wherein the method further comprises:
(a) receiving a request to access at least one of the trusted hashed firearm license data on the blockchain and the copy of the license stored on the database;
(b) determining whether the request is made by an authorized requester; and
(c) only responding to the request by sending the at least one of the trusted hashed firearm license data and the copy of the license when the request is made by the authorized requester.

21. The system of claim 20, wherein determining whether the request is made by the authorized requester is performed using computer program code stored on the blockchain.

22. The system of claim 20, wherein determining whether the request is made by an authorized requester comprises:
(a) comparing a blockchain address of a source of the request against a whitelist of allowed addresses; and
(b) determining that the request is made by the authorized requester when the blockchain address is on the whitelist.

23. A non-transitory computer readable medium having stored thereon computer program code that is executable by a processor and that, when executed by the processor, causes the processor to perform a method comprising:
(a) obtaining unverified hashed firearm license data representing a license purportedly licensing a licensee;
(b) retrieving, from a blockchain, trusted hashed firearm license data representing a license confirmed to license the licensee;
(c) comparing the unverified hashed firearm license data to the trusted hashed firearm license data; and
(d) when the unverified hashed firearm license data and the trusted hashed firearm license data match, determining that the unverified hashed firearm license data represents an authentic license of the licensee.
